(19) United States
(12) Patent Application Publication
(10) Pub. No.: US 2025/0299233 A1
(43) Pub. Date: Sep. 25, 2025

(54) Generating Dynamic Work Orders for Service Marketplaces

(71) Applicant: Omar Kharbat, Wilmington, NC (US)

(72) Inventor: Omar Kharbat, Wilmington, NC (US)

(21) Appl. No.: 18/638,198

(22) Filed: Apr. 17, 2024

Related U.S. Application Data
(60) Provisional application No. 63/611,107, filed on Dec. 15, 2023.

(51) Int. Cl. G06Q 30/0601

(52) U.S. Cl. CPC G06Q 30/0601

(57) ABSTRACT

A method, system, and program product includes an integrated artificial intelligent system for generating a work order by including processes configured to execute demand forecasting, tailored pricing, service provider matching, and dynamic job order management. An example leverages data analytics to forecast demand, determine tailored prices, match users with nearby service professionals, teams, and offers via a marketplace network, and manage job orders using a dynamic work order management tool. The system provides service delivery and enhances customer satisfaction. Generating the work order may include performing a task selected from a list that includes at least one of: demand forecasting, tailored pricing, service provider matching, and dynamic job order management. Based on the performed task, the system may match a user with nearby service professionals via a marketplace network to generate a job order and manage the job order.

### MARKETPLACES BACKGROUND

The field of the disclosure relates generally to computing technologies, and more particularly, to computer-based systems for facilitating online contracting between buyer and sellers of services.

Search engines, directories, and marketplace agencies are routinely used to connect buyers with sellers. Most of these offer free listings and some others charge advertisers for listings or have sellers pay for job leads. While these techniques might help buyers find service professionals, they also require additional actions on behalf of participants and add more expenses to both sides of the marketplace. For instance, a service provider may waste time on creating estimates, filtering calls, lining up jobs, collecting money, and marketing on social media instead of performing and delivering actual job results. Sellers must increasingly expect more travel time and fuel expenses to expand their service coverage area in order to make profits. Further complicating contracting, service sellers must often hire inexperienced helpers to perform the job so that they can have more time to line up work. Current systems may feed a perception that workers have to become a jack of all trades to survive a crowded marketplace. Current processes further pose challenges to both consumers and service providers with regard to predicting the cost or the result of the work.

Known systems further favor middlemen and large corporations, rather than the actual buyers and sellers of services. Large marketing platforms actually compete with service providers by taking job leads only to sell them back to workers at an inflated price. This factor causes the overall price of service to be higher and less tangible. In view of the above challenges, what is needed is an improved online platform for coordinating and facilitating contracts between service providers and their customers.

### BRIEF DESCRIPTION OF THE DRAWINGS

FIG. 1 depicts the workflow of a user creating an account specifically to become a seller.

FIG. 2 shows the workflow of both buyers and sellers sending and receiving custom offers.

FIG. 3 illustrates the process sellers would take to create and publish a job listing to the marketplace.

FIG. 4 explains how the system auto calculates the pricing of jobs using data reprocessing.

FIG. 5 shows the process of how buyers can instantly book directly from service sellers who publicly list their jobs onto the marketplace.

FIG. 6 illustrates images of how buyers would request custom offers from sellers and how sellers would respond with offers.

FIG. 7 displays the structure of the homepage with public job listings.

FIG. 8 shows how a chat tab may be displayed with a list of active or inactive chat rooms between users.

FIG. 9 presents an orders page with a calendar of user's appointments.

FIG. 10 shows the inside of a dynamic work order chat room between users.

FIG. 11 displays an example of a workflow consistent with an implementation.

FIG. 12 demonstrates various sellers profile set-up scenarios

FIG. 13 shows personalized demand prediction and offer recommendations.

### DETAILED DESCRIPTION

An implementation addresses the shortcomings of prior art systems by designing a work order tool for service sellers that lines up work directly with their customers rather than by connecting them through a matching system. Put another way, an example provides work order automation that allows users to directly transact with each other and instantly book appointments on a self-serve marketplace.

An embodiment comprises a digital tool used in self-serve direct marketplaces for service that provides sellers with work request automation such as pre-booked jobs and payment authorization. The dynamic work order described herein provides a streamlined and efficient process for buyers to instantly book services through a self-serve marketplace. The system leverages buyer data to calculate a price and offers real-time price quotes tailored to the specific buyer or location. Upon selecting a preferred offer, the system facilitates instant booking and escrow payment, where the payment is released upon job delivery, ensuring secure transactions between the two users. Furthermore, the system generates dynamic work orders for each transaction based on the booking details. The system will solve buyers' problem of finding reliable service while automating Customer Relationship Management (CRM), freeing service sellers to only focus on doing the actual work and delivering job results

An illustrative system includes an integrated, artificial intelligence (AI) based system that leverages data analytics to forecast demand, determine tailored prices, match users with nearby service professionals, teams, and offers via a marketplace network, and efficiently manage job orders using a dynamic work order management tool. The system utilizes advanced algorithms, machine learning, and other AI techniques to optimize service delivery and enhance customer satisfaction in a specific scenario. As described herein, an example of the system provides demand forecasting, tailored pricing, service provider matching, and dynamic job order management. An example of the system comprises hardware and associated software that includes a digital tool used in self-serve direct marketplaces for service that provides sellers with work request automation such as pre-booked jobs and payment authorization.

The dynamic work order described herein provides a streamlined and efficient process for buyers to instantly book services through a self-serve marketplace. The system leverages buyer data to calculate a price and offers real-time price quotes tailored to the specific buyer or location. Upon selecting a preferred offer, the system facilitates instant booking and escrow payment. The payment is released upon job delivery, ensuring secure transactions between the two users. Furthermore, an example of the system generates dynamic work orders for each transaction based on the booking details. Where so configured, an implementation allows a buyer to find reliable service, while automating CRM.

An implementation may reduce idle time of service sellers. Time may be conventionally wasted on errands, estimates, filtering through calls, lining up jobs, collecting money, and marketing on social media instead of performing and delivering actual job results. An example may also save travel time and fuel expenses. Service workers conventionally have to expand their service coverage area in order to make profits, making their travel time and fuel consumption higher. Furthermore, specialized service sellers typically have to hire inexperienced helpers to perform the job so that they can have more time to line up work, which takes them out of the field themselves. Where the nature of service is intangible, both consumers and service providers may not be able to predict the cost or the result of the work before the hiring process. As a result, the service is harder to transact as a product. An embodiment additionally addresses conventional challenges associated with obtaining job leads. Conventionally marketing platforms and middlemen competing for job leads end up selling them back to workers at an expensive price, causing the price of service to be higher and less tangible. Existing practices may contribute to service providers feeling pressured to become a jack of all trades to survive a crowded marketplace.

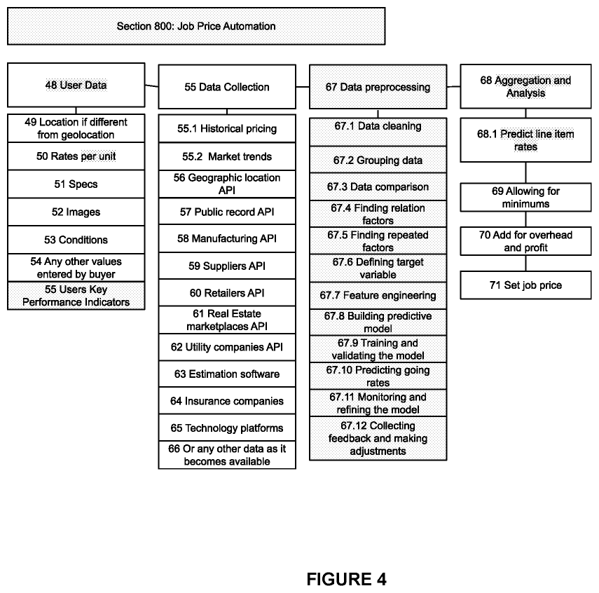

Embodiments of the invention address these issues and may additionally be applied to analogous challenges in other industries. The workflow may generate instant work orders for nearby sellers and authorize prepayments, complete with an appointment schedule with job details. The system may ensure sellers get paid properly and buyers receive results for their money. Additionally, the feature of price automation, as shown in FIG. 4, may apply on a wide range of predicting the value of services such as the gig economy, booking, lessons, renting, professional services, or any on-demand services that help in turning intangible service to be as predictable as tangible products.

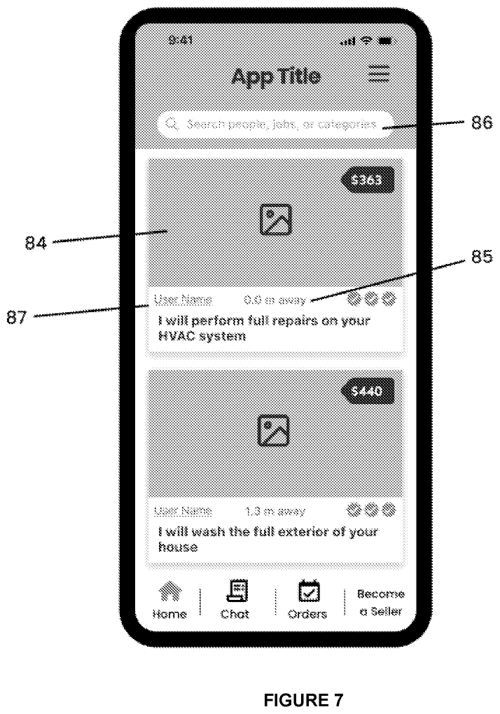

The system may address the manner in which people buy services. The more predicted the prices and results, the more the system may be configured to transact an outputted service as a tangible product. Program code by default may sort nearby job cards first, allowing users to scroll and shop for nearby, predicted, fixed price services (e.g., as shown in FIG. 7). This feature may allow sellers to present their service to buyers regardless of whether they need it or not. The workflow of the program is designed to expose shoppers to services that aren't important or urgent but are convenient to buy. It expands the market of non-essential service and allows homeowners to book simply because they want it, which is similar to buyers shopping and buying products they don't necessarily need, but still want. This feature may promote laborers being employed and keeping spendings locally focused instead of wanting, but not needing imported products.

Other benefits may include eliminating wasted time having to answer the phone and filter calls from telemarketers. The system may generate a net positive result by constantly enhancing matching for all three pillars of the market: demand, supply and service. An example of the system facilitates meeting people in person. An embodiment of the system may attract more people to work in the service industry and ease the path for young entrepreneurs to start their career.

A particular embodiment may include a module, or algorithm, that enables sellers to offer or sell their product or service directly to their buyers via a self-serve service marketplace. An instant booking function of the algorithm may provide a streamlined and efficient process for buyers to instantly book services through a marketplace. The system leverages buyer data, including preferences, location, and other relevant factors to automatically determine and output a price for the service tailored to the specific buyer or location. Once a buyer selects a preferred offer, the system facilitates instant booking, allowing the buyer to secure the desired service without delay. To ensure the safety and trustworthiness of transactions, the system integrates an escrow payment mechanism, which holds the payment securely until the job is delivered and accepted, protecting both the buyer and the service provider. The system will then programmatically generate a dynamic work order based on the booking details, enabling efficient task management. Payout to service providers occurs once the job delivery is accepted to ensure fair compensation.

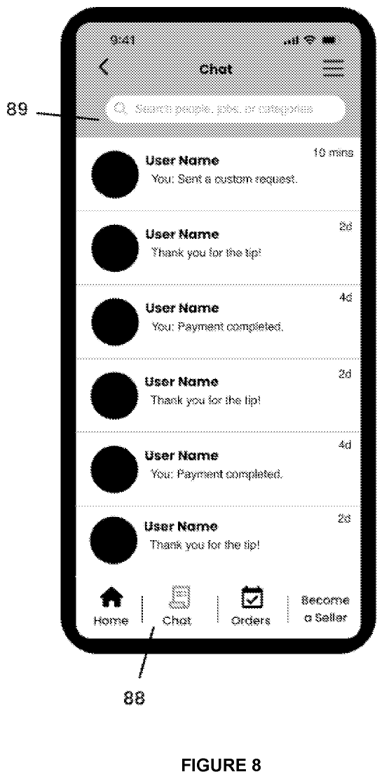

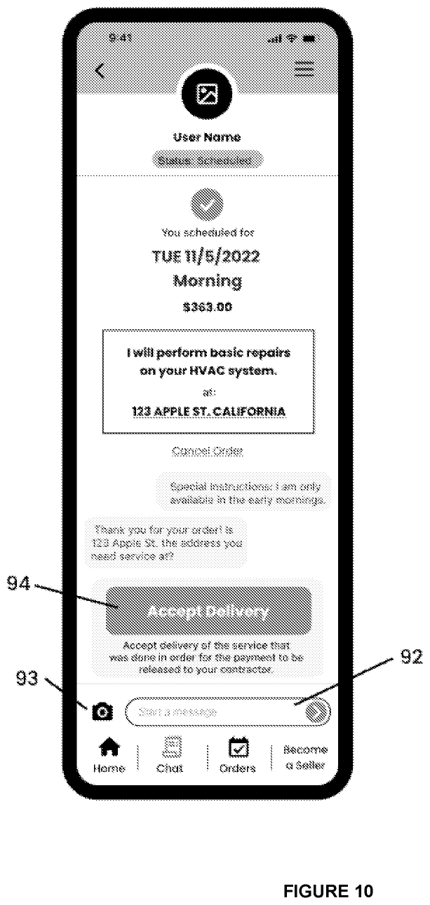

A chat room module may provide communication directly between buyers and sellers, payment collection, and public seller profiles. The chat feature may comprise a list of active and completed work orders (see FIG. 8) that allows users to access them through the chat itself or the orders page. The work order itself may be generated in the form of a chat room instantly after a customer places an order. In the chat room, users are allowed to communicate through text, upload media and complete actions such as canceling and accepting delivery of service. The dynamic work order becomes complete once the buyer accepts delivery, wherein the chat turns inactive, as shown in FIG. 10.

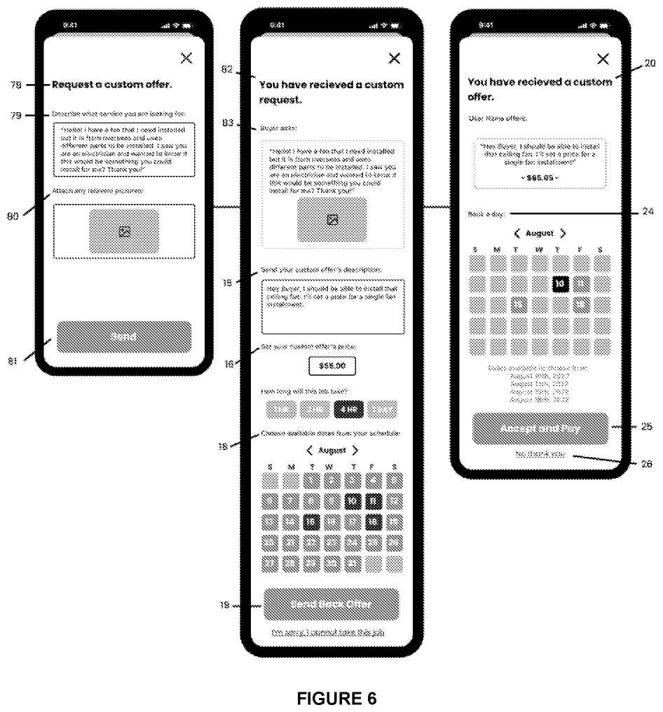

A custom offer option module may enable buyers to request unique services that are not already listed by a seller, which is done by providing a description and image(s) of the unique service they need done, as shown in FIG. 6. The custom offers are also a useful tool to increase flexibility for customers to make adjustments, such as changing order details or supplementing the original scope of work. For example, buyers can send sellers a quote request where they can describe the scope of work with text and media. Sellers can reply with a proposal along with their availability and price. Buyers can then select the day and book the service which prompts them to check out.

Implementations may include in-app notifications and push notifications outside the app to keep users informed of any actions that occur.

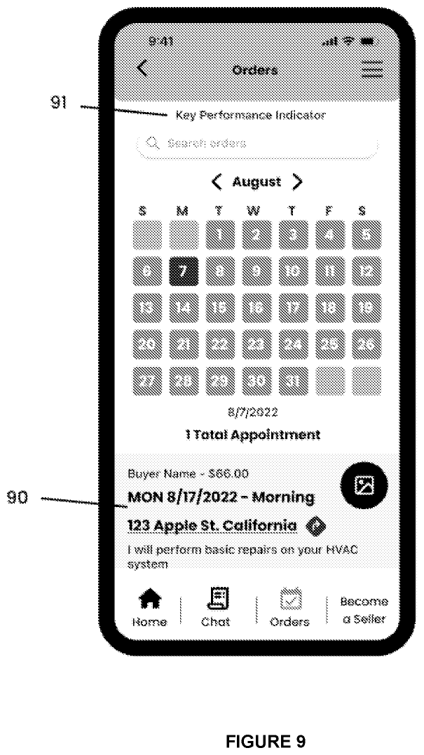

Additionally or alternatively, an implementation may include an orders page dashboard for both sellers and buyers. The dashboard shows them a thirty day calendar view of all their past, present, and future appointments that automatically updates as services get scheduled, as shown in FIG. 9.

An illustrative method performed by a system described herein may include an academy module that initiates a display of education courses to both sellers and buyers to teach planning, preparation, customer service, and do it yourself systems. As described herein, a microinsurance module may offer buyers the coverage they may need for a job. A financing module may offer buyers loans to finance their product, jobs, or projects. A ranking module may determine a level/merit score based on a sellers' total number of jobs, total sales, overall customers feedback (e.g., job score), certifications, due diligence documents, vaccinations, veteran status, group association, and availability. A matching module may match users together based on their history and data such as experienced buyers with experienced sellers.

Another module may display products and supplies for sale, such as on-demand supply house deliveries or matching products for each service using location data. This feature may allow for shipping the products in time for the service appointment.

A heat map feature may display demand by location for each specific trade. An example may include referring restoration workers to Florida during the hurricane season or farm workers to the Carolinas during strawberry season.

Another module may display appliance information by obtaining appliance models and serial numbers from sales and warranty records data of matching location. The program may also keep the information up to date by asking for users input and verification algorithms.

A digital wallet may be provided for users, allowing them to transact money between each other's bank accounts and save on payment processing fees. An accounting page module for users may allow them to keep track of their transactions and generate and print reports. Key performance indicators (KPI) may be generated to provide users with information and summaries based on their performance. A module may allow sellers to work in teams and match them using data and algorithms for large jobs. Examples include a disaster restoration or event planning service.

A module may allow sellers to set up sub-accounts to add staff members. Another module may determine a programmatic estimation of job prices by calculating quantities, obtaining rates, and using multiple sources of data including, but not limited to, users input, public data, historical sales in the platform and inquiring data from other platforms.

A module may automatically perform scaling to other industries to allow other service-oriented businesses, such as restaurants or veterinarians, to use the dynamic work order and sell their services on the platform after they set up their profile and list their items. Another module may include a crossing over of listings from different varieties of professions to be displayed in a social media form showing nearby service offers. Still another module may allow both sellers and buyers to view their past, present, and future booked orders with static and key performance indicators in their orders page.

A demand module, or algorithm, may incorporate a powerful heatmap feature that leverages advanced algorithms and predictive analytics to identify and notify users about areas and services with high demand ahead of time. This feature enables users to stay ahead of the curve, optimize their offerings, and maximize their business potential. For example, plumbers may be able to forecast when water heaters may break and the number of water heaters that the system predicts will require repair or replacement in a specific area. This prediction is made using a personalized algorithm that takes into account factors such as age, sales data, previous data, demographics, user data, and other relevant sources of information (e.g., 55-66 of FIG. 4). The demand module may output predictive analytics and notifications, helping users stay ahead of demand and capitalize on emerging opportunities. Whether it is plumbers forecasting water heater breakdowns or other service providers identifying areas of high demand, this feature enables users to make informed decisions and maximize their business potential.

A demand prediction module may include algorithms to analyze various data sources, including age, sales data, previous trends, demographics, user data, and other relevant information. By processing this data, the system may accurately predict areas and services that are likely to experience high demand in the future. For example, plumbers can forecast when water heaters are more likely to break based on historical patterns and relevant factors.

A notification module may include a heatmap function that identifies areas and services with anticipated high demand, and promptly notifies users. Users receive proactive notifications, enabling them to plan and allocate resources accordingly. This feature empowers users to prepare in advance, ensuring they can meet the needs of potential customers and capitalize on emerging opportunities.

The system may enable customization and personalization. For instance, users can utilize the demand modules' algorithms to tailor predictions and notifications to each user's specific circumstances. Factors such as the user's location, specialization, historical data, and individual preferences are taken into account to provide highly relevant and personalized insights. This customization ensures that users receive accurate and actionable information aligned with their specific business needs.

The system may enable time scrolling and forecasting. For instance, users can utilize the demand modules' time scrolling functionality to explore demand patterns over specific timeframes. By scrolling through time, users gain insights into demand fluctuations, allowing them to identify seasonal trends or recurring patterns. This capability enables users to make informed decisions about resource allocation, marketing strategies, and service planning.

The heatmap module empowers users with data-driven insights that go beyond intuitive estimations. By analyzing vast amounts of historical and real-time data, the system uncovers hidden patterns and trends that may not be immediately apparent to users. These insights provide a competitive advantage by enabling users to make data-backed decisions and optimize their business strategies.

A dynamic financial module may enable users to make informed financial decisions and automate money management. With a focus on saving, investing, and contributing, this feature offers a range of options to enhance financial well-being. The dynamic financial module employs a sophisticated algorithm that leverages data from users' financial institutions, digital wallets, and key performance indicators (KPIs). This algorithm analyzes the data to forecast budgets, identify financial insights, and recommend optimal financial moves. By harnessing the power of data analytics, users can receive personalized recommendations to maximize their financial outcomes.

In this manner, the dynamic financial module provides users a comprehensive suite of tools to improve financial decision-making and automate money management. From contribution toggles for various financial goals to integration with financial institutions and digital wallets, along with data-driven insights and planning capabilities, this feature empowers users to take control of their financial future.

The dynamic financial module may additionally provide contribution toggles that allow users to use toggle switches and percentages to allocate a small percentage of their earnings towards different financial goals. These goals include an emergency fund, kids' education fund, investments with a cap (such as Roth IRA or other chosen investment options), and out-of-pocket medical expenses and HSA contributions. By automating these contributions, users can ensure consistent progress towards their financial objectives. The module may further enable integration with financial Institutions and digital wallets: The dynamic financial module integrates with users' financial institutions and digital wallets. This integration allows users to connect their accounts, track their financial transactions, and gain a holistic view of their financial landscape. By utilizing real-time data from these sources, the feature provides a comprehensive overview of users' financial health.

The dynamic financial module may further provide a life financial statement: Users can instantly access their life financial statement, which includes a predicted total of 1099, balance sheet, and income statement. This statement provides users with a comprehensive snapshot of their overall financial position, helping them understand their net worth, income sources, and expenses. It offers a clear and organized view of their financial standing at any given time. The module additionally provides financial moves and planning: The dynamic financial module feature goes beyond providing insights and recommendations; it also assists users in planning their financial moves. By considering the user's financial goals, risk tolerance, and market conditions, the feature suggests strategic plans to optimize their money. Whether it's saving for retirement, managing debt, or investing wisely, users can access actionable plans to guide their financial decisions. The dynamic financial module may forecast insights and metrics for future performance. The system may use data sources from FIG. 4 along with user-defined KPIs, the system compiles unique and valuable data to assist each user in forecasting their future KPIs and performance metrics. A KPI module of the dynamic financial module may provide users with valuable insights and metrics to assess and track their performance in various areas. This feature offers a comprehensive set of performance indicators to help users evaluate their progress, identify areas of improvement, and make data-driven decisions.

The KPI feature may enable performance tracking that allows users to track their performance across different dimensions, such as sales, customer satisfaction, productivity, efficiency, financial metrics, and more. By monitoring these key indicators, users gain a clear understanding of their performance levels and can identify trends or patterns that impact their success. The KPI may further allow users to customize the KPIs based on their specific business or personal goals. The feature allows users to define and prioritize the metrics that are most relevant to their objectives. Whether it's revenue growth, customer acquisition, employee productivity, or any other critical area, users have the flexibility to select and monitor the metrics that matter most to them. Real-time data is also provided by the KPI feature, which provides real-time data updates, ensuring that users have access to the most current information regarding their performance. This real-time data allows users to make timely decisions and take appropriate actions to address any performance gaps or capitalize on emerging opportunities.

The KPI module further provides comparative analysis that allows users to compare their performance against predefined benchmarks or industry standards to gain valuable insights into their relative standing. This comparative analysis helps users assess their performance in relation to competitors or best practices, enabling them to identify areas where they excel or areas that require improvement. The KPI module further enables data visualization that uses advanced data visualization techniques to present performance metrics in a visually appealing and easy-to-understand format. Users can access intuitive charts, graphs, and dashboards that provide a comprehensive overview of their performance at a glance. This visual representation allows for quick and efficient analysis of trends and patterns.

Additionally, the KPI module may allow goal setting and monitoring, which allows users to establish specific targets for their key indicators. Users can set performance goals, track progress, and receive notifications or alerts when they are close to achieving their targets or when corrective action is required. The KPI module may additionally allow users to conduct historical analysis by reviewing performance trends over time. Users can access historical data to identify long-term patterns, evaluate the impact of past decisions, and make informed adjustments to their strategies or processes.

The dynamic wallet module described herein introduces a versatile and secure digital wallet that empowers users to transact seamlessly within and outside the platform, using any currency or cryptocurrency of their choice. This feature offers a wide range of capabilities to enhance users' financial experience. The module may include multi-currency and cryptocurrency transactions. More particularly, the feature may enable users to conduct transactions in various currencies and cryptocurrencies. The module supports traditional fiat currencies like USD, EUR, or GBP, as well as popular cryptocurrencies such as Bitcoin, Ethereum, or Litecoin. Users can effortlessly send, receive, and exchange funds in different digital forms. The dynamic wallet feature may further provide security and reliability by using encryption protocols and advanced security measures to safeguard users' funds. It provides a secure environment for storing and managing digital assets, protecting against unauthorized access and fraudulent activities. The digital wallet module may interface with external platforms. Users can transact with merchants, service providers, or individuals outside the platform, leveraging their wallet funds in any supported currency or cryptocurrency. This facilitates convenient and efficient cross-platform transactions. The dynamic wallet may include its own digital currency. This unique currency may be directly tied to the US Treasury, ensuring stability and reliability in its value. Users can utilize this currency for transactions within the platform or convert it to other supported digital assets. The module may include a user-friendly interface that simplifies fund management and transaction processes. Users can easily navigate through their digital assets, review transaction history, and perform various wallet operations with ease. The intuitive design enhances user experience and usability.

To facilitate accurate and transparent transactions, the dynamic wallet module may provide real-time exchange rates for different currencies and cryptocurrencies. Users can access up-to-date market rates, enabling informed decisions when exchanging or converting their digital assets. The wallet maintains a comprehensive record of users' transaction history, ensuring transparency and accountability. Users can access detailed transaction logs with timestamps, transaction amounts, and recipient information. Furthermore, the wallet offers analytics and insights into users' spending patterns, empowering them to make informed financial decisions and manage their funds effectively.

In this manner, the dynamic wallet module may provide a versatile and secure digital wallet. With support for multiple currencies and cryptocurrencies, seamless integration with external platforms, and the introduction of a stable digital currency, the wallet offers users a seamless and convenient financial ecosystem. Whether transacting within the platform or conducting cross-platform transactions, the wallet empowers users with flexibility, security, and innovative features to enhance their financial experience. This patent application seeks to protect the unique aspects and functionalities of the module, providing a competitive advantage in the digital wallet landscape.

An implementation may include team formation for collaborative service ordering. This module may enable buyers to order services from multiple sellers and form cohesive teams based on their specific needs. The module utilizes an algorithm that matches sellers with other sellers, creating teams that can efficiently address complex tasks. This feature has a wide range of applications, including farmers hiring farming crews, contractors assembling skilled teams for specialized projects, and insurance adjusters forming mitigation crews comprising various trades such as flooring, electricians, plumbers, and movers.

The team formation module employs a systematic approach to streamline the process of team formation and service ordering. As such, the module may perform algorithmic matchmaking that analyzes the buyer's requirements and matches sellers with complementary skills and expertise. The module takes into account factors such as location, availability, qualifications, and past performance to create optimized teams tailored to the specific task at hand. The module may further perform seamless work order management. Once the team is formed, the system automatically generates work orders, detailing the scope of work and assigning responsibilities to each team member. This ensures clear communication and coordination among team members, minimizing confusion and optimizing productivity. Another feature of the module may include payout and disbursement management. This algorithm may simplify financial transactions within the team by handling and disbursing payments to individual team members. This eliminates the need for manual calculations and ensures prompt and accurate payment distribution, enhancing transparency and trust among team members. A credit and score system may incentivize sellers to participate in the team formation module and promote effective collaboration. To this end, the system credits sellers with additional scores for enrolling and demonstrating their ability to work well with others. This score serves as a measure of a seller's teamwork proficiency and can enhance their reputation within the platform.

The team formation module provides numerous benefits to both buyers and sellers. Buyers can easily assemble competent and coordinated teams tailored to their specific needs, ensuring efficient and high-quality service delivery. Sellers benefit from expanded opportunities to collaborate and gain recognition for their teamwork skills, which can lead to increased business prospects and improved reputation within the platform. In this manner, the team formation enhances ordering services by enabling buyers to form specialized teams from multiple sellers. The algorithm, streamlined work order management, seamless payment disbursement, and credit system collectively enhance efficiency, collaboration, and overall service quality. An implementation seeks to protect the unique aspects and functionalities of the Team Formation feature, offering a competitive advantage in the marketplace of collaborative service ordering.

Team formation goes beyond conventional systems by allowing buyers to order services from multiple sellers simultaneously and create cohesive teams tailored to their specific needs. This system utilizes an algorithm that matches sellers with each other, facilitating the formation of efficient teams capable of tackling complex tasks. The applications of this feature include scenarios such as farmers hiring farming crews, contractors assembling specialized project teams, and insurance adjusters forming mitigation crews consisting of various trades like flooring, electricians, plumbers, and movers, all through a single work order request.

The disclosed system is unique when compared with other known systems and solutions in that it allows service workers to offer their product or service directly to buyers while providing automated work orders. The system gives service workers the opportunity to publish any credentials/certificates, set up their time availability for buyers to schedule from, set their own flat rate price rates for each job, and connect their payment method. The program code may automatically suggest services with users based on their geographic location and data algorithms. Furthermore, buyers are able conduct their own research on sellers and manage their own work orders from start to finish with the ability to communicate directly to the hired service seller. The system allows buyers to book instantly and release payments to the seller once they accept the job delivery. The invention replaces the need for tasks such as estimating errands, answering phone calls, manual scheduling, invoicing, and collection with automatically sending booked, payment-authorized work orders to service sellers. The platform will eventually reduce wasted idle time, fuel, and energy, while also helping workers become more specialized and minimizing middle management involvements.

The disclosed software is different from other known systems by virtue of providing a dynamic work order that allows sellers to line up work autonomously once they set up their profile and add their listings. Another improvement provides a way for buyers to browse job listings from service sellers on a digital marketplace and book from them directly and instantly. Still another improvement allows sellers to create and send custom job offers and receive back booked, authorized orders. Another improvement allows buyers to request custom quotes for work that sellers can respond with the above described custom job offer. Similarly, the associated software is unique in that both sellers and buyers have the ability to communicate directly via a chat room feature and complete the work order cycle once buyers accept delivery of the service. Within the chatroom, sellers and buyers can further review the work order content and have the option to cancel or proceed with the service.

Referring more particularly to the figures, the drawings and specific descriptions of the drawings, as well as any specific or alternative embodiments discussed, are intended to be read in conjunction with the entirety of this disclosure. The software, method, and system for generating dynamic work orders for service marketplaces may, however, be embodied in many different forms and should not be construed as being limited to the embodiments set forth herein; rather, these embodiments are provided by way of illustration only and so that this disclosure will be thorough, complete, and fully convey understanding to those skilled in the art.

In operation, the user may initiate the software, which opens up directly to a homepage with public job listings sorted by a nearest distance. The user of an implementation then may have three options to move forward. For example, they may log in, join Now, and become a seller. The latter feature may assist new users who want to go straight to becoming a seller. The user will choose one of these and sign up as buyer or seller.

The seller account sign up process begins with collecting the seller's information and credentials, which includes their First name and Last name, Email, Password, Address, Phone number, Documents, and Verification of seller's identity. Next is for the user to set up their seller profile, which includes a profile picture, biography, and schedule of availability.

The platform offers an online profile feature that allows sellers to showcase their expertise, credentials, and reputation to potential customers. This feature enhances the visibility and credibility of sellers, helping them attract more clients and secure new opportunities. Here are some key components of the online profile. The profile may include an expertise and credentials showcase: Sellers can leverage their online profile to highlight their skills, experience, qualifications, and relevant certifications. They can provide detailed descriptions of their services, including the industries they specialize in, specific areas of expertise, and any unique selling points. By presenting their credentials upfront, sellers can establish themselves as trusted professionals in their respective fields.

The profile may include sharing, which allows sellers to utilize the online profile feature to share important documents, such as portfolios, case studies, certifications, and licenses. By providing access to these documents, sellers can demonstrate their track record of successful projects and showcase tangible evidence of their capabilities. This helps potential customers make informed decisions and builds trust in the seller's abilities.

The profile may include trust and safety enhancements. As part of the online profile feature, background checks can be incorporated to provide an additional layer of trust and safety. Sellers can undergo verification processes, such as identity verification and background screening, to ensure customers of their reliability and integrity. This measure contributes to a secure and trustworthy marketplace environment.

The profile may include recommendations and endorsements. Sellers can leverage the online profile feature to request recommendations from their trusted peers and clients. These recommendations serve as endorsements of the seller's services and provide social proof of their expertise and professionalism. Potential customers can review these recommendations to gain insights into the seller's performance, reliability, and customer satisfaction levels. This feature helps sellers build credibility and attract new clients.

An online profile may allow sellers to showcase their expertise, share important documents, undergo background checks, and request recommendations, the platform enhances the overall user experience and promotes a trusted and secure marketplace. Sellers can establish their credibility, while potential customers can make informed decisions based on reliable information and endorsements.

To further allow sellers to showcase their expertise, The platform incorporates a comprehensive marketing funnel to help users attract and engage potential buyers, nurture leads, and maximize their reach. The marketing funnel encompasses various stages and strategies to effectively promote users' profiles, listings, and offers. A marketing funnel module may include a lead generation feature to generate potential demand, the platform provides users with options to set the system to automatically or manually generate a list of potential buyers. This list can be curated based on specific criteria such as location, preferences, or past interactions. By leveraging this feature, users can expand their target audience and increase the chances of reaching interested buyers. Email marketing may include users can utilize the platform's email marketing functionality to send reminders, updates, or promotional messages to potential buyers. Whether it's automated email campaigns or personalized messages, this strategy helps to keep potential buyers engaged and informed about new listings, offers, or any other relevant updates. Email marketing serves as an effective tool to nurture leads and encourage conversions. A contact invitation feature may allow users to invite their contacts from any source to view their profiles, listings, or offers. By leveraging their existing networks, users can expand their reach and tap into potential buyers who may have a genuine interest in their services. This feature helps users leverage their personal and professional connections to create awareness and drive engagement.

A social media integration feature/software may enhance visibility and reach a wider audience, the platform seamlessly integrates with users' social media accounts.

The system automatically feeds linked social media accounts with user updates, such as new listings, added due diligence documents, reviews, and other noteworthy information. This integration enables users to effortlessly share their updates with their social media followers, attracting potential buyers and increasing exposure.

The marketing funnel empowers users to effectively market their services, engage with potential buyers, and drive conversions. Whether through lead generation, email marketing, contact invitations, or social media integration, users can optimize their marketing efforts and leverage multiple channels to expand their business reach.

Once they set up their online seller profile, they will then connect the seller's payment gateway to their account. Now that the set-up process is complete, the software can unlock features of the seller's account. The navigation bar will change from just a “Login” button to instead show seller's tabs, which include “Home,” “Chat,” “Orders,” and “List.” The platform also gives sellers the option to share their profile with contacts or other social media platforms, including embedding their profile into websites or other platforms.

Sellers can now also send custom offer proposals to buyers, which is done by going to the List tab of the bottom menu. There will be two buttons, the first will allow sellers to send custom offer links to users outside of the app. When they wish to create a custom offer, they will fill out a form with the following information: A text field to describe the custom offer, a price offer field, and a calendar where they can select multiple dates of availability for the buyer to choose from. They can then send this form in the form of a link to their contacts.

When a buyer requests a change to an offer, the transaction will be canceled, and the seller will generate and share a new offer. When a buyer decides to add more items later in the process, the program code may prompt the seller to generate and share a new offer. When a buyer does not have an account, the buyer will be prompted to sign up seamlessly once they view and decide to accept the offer. Sellers who wish to use the platform but do not yet have an account may be guided through a frictionless onboarding process once they choose to share their service. When communication is difficult between buyer and seller, the system is equipped with a messaging system or provides translation to facilitate smooth communication between the buyer and seller. Should a buyer request a refund or cancellation after accepting the offer, depending on the refund or cancellation policy outlined in the provided guidelines, the order can be marked as canceled, and the transaction will be reversed to return the money to the buyer. The same solution would apply if a credit card payment declined or phone verification didn't go through. When a seller fails to deliver the product or service as described. Response: If users fail to resolve the issue on their own, they can then proceed with a dispute resolution process to address instances where the seller fails to meet the agreed-upon terms. Where technical issues or errors during the transaction process occur, a support team or system is in place to quickly address and resolve technical issues that may occur during the transaction.

Where currency conversion and international payment processing is helpful, the platform provides a secure and reliable payment gateway that supports multiple currencies and facilitates smooth international transactions. In the case that the task necessitates shipping and there have been logistical challenges, the program code will ensure transparent shipping options, furnish tracking information, and establish protocols to effectively address any shipping issues, including delays or instances of lost packages. When a price Automation Failure under Unusual Demand from Circumstances such as Pandemics or Natural Disasters, the price automation systems are designed to streamline the process of estimating and setting prices based on various factors and data inputs. However, these systems may encounter challenges when faced with unusual demand resulting from unforeseen circumstances such as pandemics, natural disasters, or other significant events. During such situations, the normal patterns and data points used for price calculation may no longer be applicable or reliable, leading to potential failures in the automated pricing process. In the context of the provided input, where various data sources are used for aggregation and analysis, there are potential solutions that can mitigate the challenges posed by unusual demand: 1. Real-Time Data Updates: Incorporating real-time data feeds from relevant sources, such as news updates, emergency services, or government agencies, can help the system stay informed about the circumstances and adapt pricing strategies accordingly. This can involve monitoring the impact of a pandemic or natural disaster on supply chains, availability of resources, or changes in market dynamics. 2. Dynamic Pricing Algorithms: Implementing dynamic pricing algorithms that can respond to sudden changes in demand and supply can be valuable during unusual circumstances. These algorithms can consider factors like scarcity, increased costs, or shifts in customer behavior to adjust prices in a way that reflects the changing market conditions. By continuously analyzing data inputs from different sources, the system can dynamically adapt the pricing strategy to balance supply and demand. 3. Human Intervention and Oversight: While automation is useful in many cases, having human oversight and intervention is crucial during extraordinary circumstances. Human experts can monitor and evaluate the situation, assess the impact on pricing, and make informed decisions to override or adjust automated pricing algorithms. This human element ensures that the system remains flexible and responsive to the unique challenges presented by unusual demand. 4. Historical Data Analysis: Analyzing historical data from previous instances of unusual demand or similar events can provide insights into how pricing was affected in the past. By studying the patterns and trends observed during those periods, the system can better predict and prepare for future situations, enabling more effective price adjustments. 5. Regular System Updates and Maintenance: Ensuring that the system is regularly updated with the latest data sources, APIs, and algorithms is essential. This helps to incorporate any new information or advancements in data collection methods that may arise from ongoing research, technological innovations, or evolving data standards. By combining these solutions, the price automation system can better handle unusual demand resulting from circumstances like pandemics or natural disasters. It can adapt to changing market dynamics, consider real-time data updates, leverage historical insights, and integrate human expertise when necessary. These measures help to mitigate the risk of pricing failures and enable the system to provide accurate and relevant pricing information even in challenging and unpredictable situations.

Moving forward, seller accounts are also allowed to create and list flat rate services on the marketplace. In the List tab of the bottom menu, there are two buttons; the first button was described in the previous paragraph while the second is for creating flat rate listings to publish on the marketplace. The form to create a new job includes, but is not limited to, the following information: (1) A picture representing the job; (2) A title of the job; (3) A description of the job; (4) What the job specifically includes; (5) What the job specifically does not include; (6) The price of the job; (7) How long the job duration is; and (8) Buttons at the bottom to save any edits or publish their job to the marketplace. Once saving, they can view a list of all their current active jobs and clicking on any job will allow them to edit the information.

Becoming a seller also allows the system to programmatically calculate quantities and estimate job prices as data becomes available, as explained in FIG. 4. Auto estimates are programmatically calculated job rates, estimates, or scopes of work using three or more metrics: (1) Items or service performed (2) Rates and (3) Quantities. These metrics can be manually entered by the users or obtained programmatically via system data or third party data such as but not limited to manufacturers, public records, and other estimation programs. More useful data will become available for more accurate estimates as building products and materials evolve. A few elements that will enhance accuracy of the dynamic work order innovation include smart homes of the future, prefabricated home manufacturers' shared data on their building components, and their buyers' geolocation. When users share their location, the platform simply obtains available data and programmatically estimates needed quantities, materials prices, and labor rates.

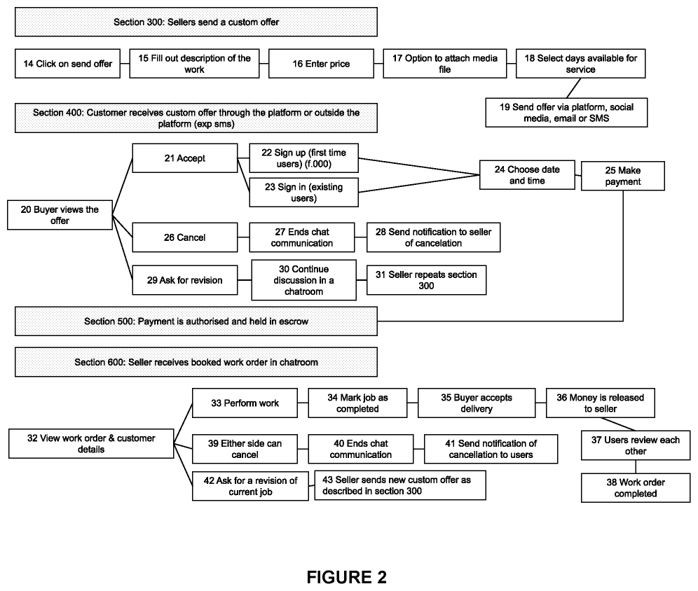

The buyer's account sign up process begins with collecting the buyer's information and credentials, which include: (1) First Name and Last name (2) Email (3) Password (4) Address (5) Phone number. Once this process is complete, the program will unlock features of a buyer's account. The bottom navigation bar will convert from just a “Login” button to instead show the buyer's tabs, which include “Home,” “Chat,” “Orders,” and a button that allows them to convert to a seller profile labeled “Become a Seller.” Buyers are now allowed to browse or search listings on the marketplace homepage which shows listings as rectangular cards in a single, scrollable column. When buyers click on a job, they can view the job details of the listing, select a day from the calendar, and book. The information on this page includes: (1) A description of the job; (2) Two sections for what the job includes and does not include; (3) The job duration; and (4) A breakdown of what the total price would be. The creation of a buyer account also allows buyers to request a quote for custom jobs (See FIG. 2.) from the seller's profile page, which they can access by clicking the name of the seller on one of their public job listing cards. Buyers will click on the option to request a custom offer from the section in the seller's profile that shows that seller's other services. They then fill out a form with two fields, one asking for a description of the custom job that needs to be done and the other for uploading any pictures they wish to send. The buyer then sends the form which the seller receives in their chatroom and can respond to. The seller's response form includes a text field to answer their request, a price offer field, and a calendar for which they can select multiple dates of availability for the buyer to choose from. At the end of the form are two buttons, one for the seller to send the offer form back and one to decline the request. If they do send the offer back, the buyer then receives it in their chatroom where they can see the seller's offer, price, and available days to pick from. They can select a day and book with the “Book” button at the bottom of the form, which leads them to make a payment and opens up a chatroom, the same as when booking through a normal job listing. If the buyer does not want to book, they can choose the button at the bottom of the form to decline the offer, which then ends the custom offer communication between the two.

When a buyer requests a custom offer from non-users, the system will allow sharing via other social media, email, or SMS. Sellers will be able to view the request via a temporary URL and will be promoted to a frictionless onboarding process during the creation of the offer. When the buyer does not have an account, the system will prompt buyers with a frictionless signup component while sending the request. When the buyer does not accept the offer, the system will prompt the buyer to send a new request to counter when they decline the offer.

The system may implement language translation tools or services to facilitate communication between buyers and sellers who speak different languages. The system may further allow direct messaging to allow direct and transparent communication between buyers and sellers to discuss expectations, clarify any uncertainties, and negotiate terms before finalizing the offer. The system offers a standardized form or questionnaire for buyers to fill out, guiding them to provide all necessary information for the custom request. Fields for buyers may include specific details, measurements, or examples to better convey their requirements. The system may enable a messaging system between buyers and sellers to allow for clarifications and follow-up questions. The system may provide a mechanism for sellers to request additional information or clarification from buyers when faced with complex requests. The system may offer resources or tools to help sellers evaluate the feasibility and pricing of unique or complex requests. The system may utilize a project management system to break down complex requests into smaller, manageable milestones to ensure clarity and progress.

An embodiment of the system may display any due diligence documents provided by the sellers to the buyers, allowing them to conduct their own investigations prior to hiring. A Merit Score module keeps track of important factors to recommend sellers based on their past job history and the amount of repeat business they have. The system also provides a rating and review system where buyers can provide feedback on their experience with sellers, helping to establish trust and credibility. The platform offers micro insurance along with buyer protection programs or guarantees to provide assurance and build confidence in the custom offer process. The system may facilitate transparent communication and provide channels for buyers to ask questions or request references from previous customers.

Regarding dispute resolution, the system may offer guidelines for negotiation and revision processes, including expected response times and a structured approach to address changes. In the event the platform connects nearby users, facilitating local dealings and transactions, users can utilize their local court system to resolve any disputes that may arise. The platform holds the money in escrow until a judgment is provided by one of the users, and then releases the funds to the winning side.

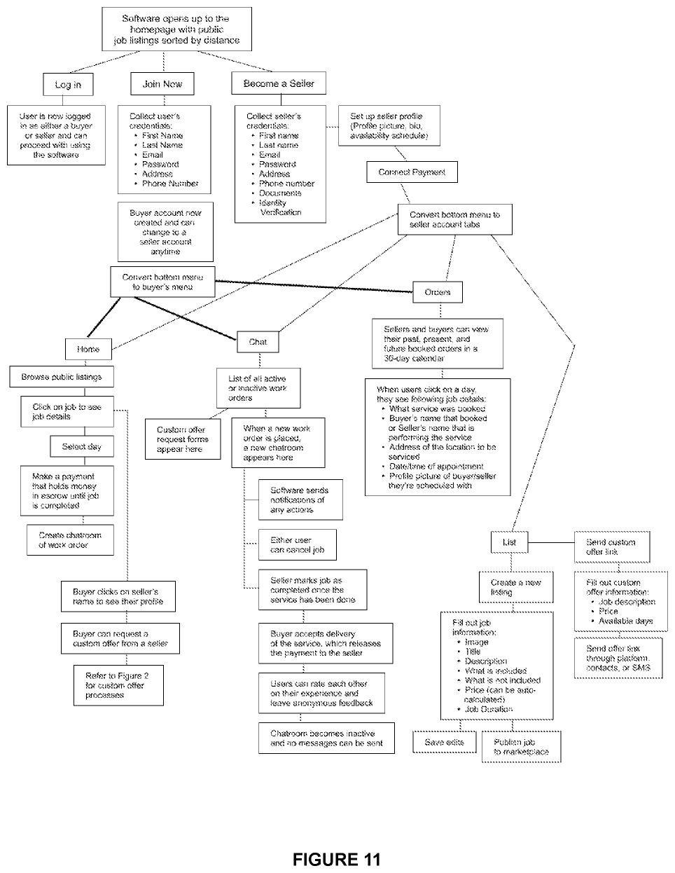

When a job is booked by a buyer, they are prompted to make a payment which then is held in escrow until the job is completed (authorized payment). After the buyers complete the authorized payment of a job, the software generates a work order with details in the form of a chat room between buyers and the seller they booked from. From here on in the chatroom, the software can: (1) Send notifications for both buyers and sellers on any further actions, which can be in the form of a drop down banner notification and a small, red dot with the number of unread messages displayed; (2) Allow users to directly cancel or communicate further details; (3) Allow sellers to mark job as completed; (4) Allow buyers to accept delivery or continue the chat to request further adjustments; (5) Allow users to rate each other once the job delivery is accepted; (6) Allow users to communicate for another 2 days before the ability to send messages back and forth is terminated, with the chatroom remaining indefinitely as a digital receipt. The software allows both sellers and buyers to view their past, present, and future booked orders with static and key performance indicators in their Orders tab (e.g., in FIG. 9). This page contains the user's schedule in the form of a 30 day calendar. Users can click on a day to see what appointments are/were scheduled on that day. The information included on the appointment includes but is not limited to: (1) Who booked the job; (2) What job was booked; (3) The address of the buyer, which they can click and redirect to the Apple/Google Maps apps; (4) The buyer's profile picture; and (5) The date and time of the appointment. FIG. 11 for the full workflow of the entire software and method.

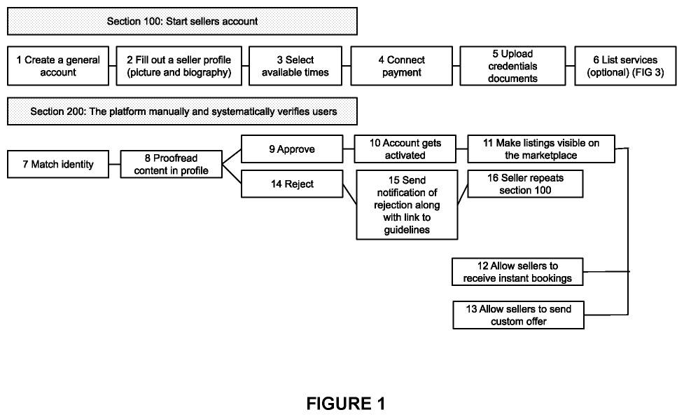

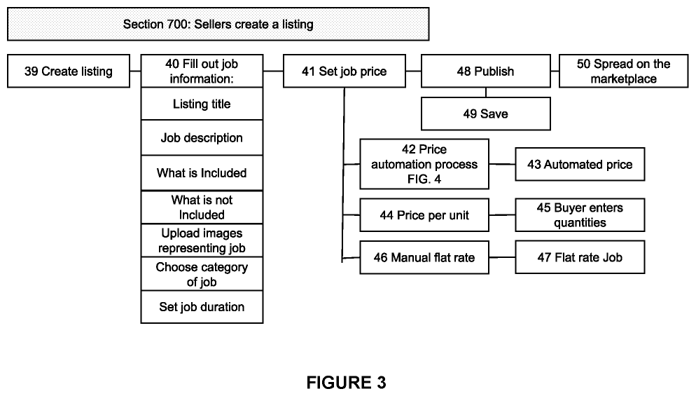

FIG. 1 shows the workflow steps of how to create a seller account on the platform (section 100) and the verification of seller accounts (section 200). The user starts off by clicking on the button to join and create a general account 1. This action includes the entering of the required account credentials such as username, password, email, phone number, and address. Next the user will fill out their seller profile 2, which contains information that will be publicly displayed for buyers to view and read. This includes a profile picture and short biography describing themselves. The next step 3 involves the user selecting their available times of service from a 7-day schedule. The user then connects their form of payment 4 which allows them to receive the money they earn from bookings. Finally, users can upload any certifications, credentials, or documents 5 they want to display for buyers to view. Once these steps are completed, the users are allowed to begin creating services to list 6 as described in FIG. 3. However, before listings can be visible on the marketplace, the platform must manually and systematically verify the seller account's information (section 200). The first step of action is to match and verify the identity of the user who created the account 7. The content in the profile also must be proofread 8 to ensure there is no profanity or inappropriate content. From here on, the account will either be approved 9 or rejected 14. If the account is approved 9 then the account gets activated 10 and the listings the seller created will be made visible on the marketplace 11. From there, sellers are also now able to receive instant bookings from buyers 12 and are allowed to receive and send the feature of custom offers 13 which is described in FIG. 2.

More particularly, FIG. 2 demonstrates the process of sending custom offers (section 300) and the steps that occur afterwards. The seller begins the process by clicking on the send offer button 14. From here, they will fill out a field describing the custom service they will perform 15 and choose their price 16. They then have an option to attach any media files 17 to further demonstrate the service they will be providing. After this, the user will be required to select which dates they are able to perform this custom service 18. Finally, they are done with the form and can send this custom offer in the form of a link 19 through email, messages, social media platforms, etc.

FIG. 2 then illustrates the experience of buyers receiving a custom offer from a seller 400 either through outside the platform or through the platform itself. This process starts off with the buyer viewing the offer 20 the seller has sent. From here they have three options, to accept the offer 21, cancel the offer 26, or ask for a revision 29. If they choose to accept the offer 21, users will need to either create an account if they are first users 23. Once the user is logged in, they will choose the date and time they would like to have this service done 24 from the available days set by the seller in step 18 of section 300. They can now be prompted to make a payment 25, which will have the money held in escrow until after the delivery of service is completed 500. The second option the buyer has after viewing the seller's offer is to cancel 26, which rejects the offer proposed by the seller and ends the communication between them 27. A notification will be sent to both buyer and seller confirming that the custom offer has been canceled 28. The last option for the buyer to respond is to ask for a revision on the offer 29. This will allow the buyer and seller to communicate further in a chatroom and discuss a more ideal and exact service offer for either user 30. Once they reach an agreement about the custom offer details, the seller can repeat section 300 to create another custom offer and send it to the buyer to book 31.

From here, FIG. 2. shows how sellers will then receive the buyer's booked appointment in their chatroom (section 600). They can open up the new appointment and view all the details about the service they are scheduled for 32, including what the service booked is, where the service will be, when, how much the total price was, and who scheduled. There are now three options both users can take from here on out, with the first option being that the seller continues with the booking and performs the work 33. The seller will perform the service on the scheduled day and once finished, they will return to the chatroom and mark the job as completed 34. This notifies the buyer that the service is fully completed and allows them to accept that the delivery was successfully done 35. Now that the delivery is accepted, the money in escrow will be released to the seller 36 and the two users can give each other anonymous, private reviews on their experiences with each other 37. The work order is now completed 38. The second option both users can perform once a job is booked is to cancel the appointment 39. This option ends the chat communication 40 and sends notifications to both users that the service was canceled 41. The last option a buyer can choose to do is ask for a revision of the current job offer 42, which may happen in the case that an additional custom service might be needed to carry out the service that is only discovered on the site of the job. From there, a seller can repeat section 300 and send the buyer a new custom offer with the specific additional service that was needed 43.

FIG. 3 follows the complete process on how a seller can create a job to list onto the marketplace (section 700). They begin by clicking on the button to create a listing 39. There will be multiple fields of information they have to fill out 40 that are required for the job to be published. This includes a listing title which summarizes the job, a job description that gives more details about the service, what specifics are included and not included, any images representing the service, the job's category, and the duration of the job. At the end, sellers will have to set the job price 41, which can be done three different ways. The seller can set the price using auto calculation 42, which refers to the process in FIG. 4 where prices are automated based on user data information. The second way to choose a price is to have the price set per unit 44, where the buyer can choose multiple quantities of a service when booking an appointment 45. The last way to set a price would be to manually enter a flat rate price 46 for the service which creates a flat rate job 47 for the marketplace. Once the seller successfully inputs a price for the service, they can save the progress of the listing 49 or publish it 48. If published, the listing can then be spread and viewed publicly on the marketplace 50.

FIG. 4 explains how the software would calculate the pricing of service jobs automatically by collecting user databases compounded with data from other sources or platforms. The system then uses programs or any form of automation to search large sets of data for patterns and trends, turning those findings into business insights and price predictions. An embodiment relates to a system and method for predictive modeling of going rates using SQL queries. The system collects relevant data on historical pricing, market trends, and other factors influencing rates. The data is then cleaned and preprocessed to handle missing values and outliers, employing SQL queries for efficient data manipulation. Grouping data by related and similar attributes allows for meaningful comparisons and identification of patterns. The invention further includes determining the relation factor based on temporal, contextual, and relational attributes, utilizing SQL queries for data aggregation and filtering. Repeated factors are also identified to uncover recurring trends and behaviors. A predictive model is built using machine learning algorithms and SQL queries, incorporating feature engineering techniques to create additional features impacting rates. The model is trained and validated using a split of prepared data, optimizing its performance. By providing new input data through SQL queries, the trained model predicts going rates, enabling accurate rate forecasts. Continuous monitoring, refinement, and periodic updates of training data ensure the model's effectiveness. Additionally, human feedback is collected to make algorithmic input adjustments, enhancing the predictive modeling capabilities.

An implementation provides an innovative approach that combines the power of SQL queries for data manipulation and machine learning algorithms for predictive modeling. This enables efficient handling of large datasets, accurate rate predictions, and continuous improvement based on the digital work order platform's real-world feedback.

User data 48 plays a role in price automation as it provides valuable information about the buyer, their preferences, and purchasing patterns. The following user data is typically needed for price automation. The user's name helps personalize the interaction and create a more tailored pricing experience. The email address allows for communication and sending relevant pricing information or updates. A contact number enables direct communication with the user, if necessary. Demographic information helps in understanding the user's preferences and targeting specific pricing strategies. Knowing the user's past purchases allows for personalized pricing recommendations based on their previous buying behavior. The user's wishlist helps identify their interests and preferences, aiding in suggesting relevant products and prices. If the user is part of a loyalty program, their membership details can influence pricing and discounts offered. Access to the user's social media profiles can provide additional insights into their preferences and interests. If the user's current location differs from their geolocation, it is important to collect their updated location data. This information helps in determining accurate pricing based on regional factors, such as taxes, shipping costs, or currency conversion rates. Rates per unit refer to the pricing for individual units of a product or service. This data is crucial for price automation as it forms the basis for calculating the total price based on the quantity or volume required by the buyer. Specs (i.e., specifications) encompass the detailed features and attributes of a product or service. The specifications data helps in determining the price by considering the quality, performance, and functionality of the offering.

Images 52 play a role in price automation, particularly in e-commerce. High-quality images allow users to visually assess the product or service, influencing their perception of value and willingness to pay a certain price. Conditions 53 refer to any specific terms or conditions that affect the price. For example, discounts, promotions, bundle deals, or limited-time offers may impact the final price calculation. Any other values entered by the buyer 54 may be related to the system considering other values entered by the buyer during the purchasing process. These could include customization options, additional services, or specific preferences that influence the final price.

User KPIs 55 are metrics that measure the user's behavior and engagement with the pricing process. Examples of user KPIs include click-through rates, conversion rates, average order value, or customer lifetime value. Analyzing these metrics helps in optimizing price automation algorithms to improve user experience and drive desired outcomes.

In addition to the factors mentioned earlier, there are several other elements that can influence rates and play a significant role in the estimation and pricing process. These factors can provide valuable insights and help determine accurate pricing for services. Let's explore these factors in detail.

The Geographic Location API is a communication interface that identifies a user's location and provides information about their geographical position. By utilizing this API, data related to the user's location, such as street addresses, time zones, currencies, real-time map navigation, and geotracking, can be obtained. This information helps in understanding the specific location-related aspects that may impact service rates, such as regional labor costs or local market dynamics.

The Public Records API allows access to state and county tax records on properties. By utilizing this API, valuable data on property-related information, including ordinance, building codes, home size, lot size, number of stories, age, and value, can be obtained. This data can provide insights into the characteristics and condition of properties, influencing the estimation and pricing process.

The Manufacturers API enables the retrieval of information about item specifications, ingredients, repair manuals, maintenance recommendations, and other relevant details directly from manufacturers. This data helps in understanding the specific requirements, complexities, and costs associated with servicing particular items, influencing the estimation and pricing process. The Supplies API 59 facilitates the search for data on home improvement supplies, contractor supplies, and more. By accessing this API, information on item prices, descriptions, depreciation, and other relevant factors can be obtained. This data assists in accurately estimating the costs of materials and supplies required for the service, thereby influencing the pricing process. The Retailers API 60 allows for the exploration of department store or furniture retailer data. By utilizing this API, information on items sold date, the person sold to, delivery location, and other relevant details can be obtained. This data aids in understanding market trends, sales history, and customer preferences, influencing the estimation and pricing process. The Real Estate Marketplaces API 61 provides access to data on home specifications, images, sales history, market value, and more. By utilizing this API, valuable insights into property characteristics, market trends, and property values can be gained. This data influences the estimation and pricing process by considering the specific features and market dynamics of properties.

The Utility Companies API 62 offers data that can help determine the type of appliances used, such as gas or electric, along with additional information related to energy consumption and usage. This data contributes to understanding the energy requirements of the service and can influence the estimation and pricing process accordingly. The Estimate Software API 63 integrates with various software tools, including auto, construction, restoration, and remodeling software. By utilizing this API, data on line-item details such as prices, descriptions, depreciation, waste, minimums, labor overhead, profits, and more can be accessed. This data assists in accurately estimating the costs associated with different aspects of the service. The Insurance API 64 provides access to data on statistics, frequencies, and incidents such as water heater leaks, sourced from departments like the Department of Insurance, insurance carriers, adjusters, or agents. By utilizing this API, valuable insights into risk factors, insurance claims, and industry trends can be obtained. This data influences the estimation and pricing process by considering the potential risks and associated costs. Technology platforms 65 encompass various tools and resources, including analytic databases, software, data, artificial intelligence (AI), machine learning, and the Internet of Things (IoT). The category of “Any Other Data as It Becomes Available” 66 refers to the constant evolution of technology and the continuous innovation in data collection and sharing methods. This includes departments like OSHA (Occupational Safety and Health Administration) or the Department of Labor, which are constantly updating their systems and gathering new data through APIs or JSON formats. As new data sources emerge and become accessible, they can be integrated into the aggregation and analysis process. This ensures that the system remains up-to-date with the latest information and can leverage new data sets to enhance business insights and predictions. By incorporating this ever-evolving data, the estimation and pricing process can be further refined to provide accurate and relevant rates based on the most current information available. Data Cleaning and Preprocessing 67 may clean the data by handling missing values and outliers. This can be accomplished using SQL queries to filter out or impute missing values and identify and address outliers. Grouping Data may group the data by related and similar attributes using SQL queries. For instance, you can utilize the GROUP BY clause to group data based on specific columns. Data Comparison 67.3 may compare the grouped data to identify patterns and relationships. SQL queries can be employed to compare data between different groups or categories.

Finding the Relation Factor 67.4 may analyze the data to discover factors that are related to the rates. This can be achieved using SQL queries to filter and aggregate data based on various attributes such as time, location, products, and individuals involved. Finding the Repeated Factor 67.5 Identify any recurring patterns or trends in the data using SQL queries. Functions like COUNT( ) and GROUP BY can be used to identify repeated occurrences of specific factors. Defining the Target Variable 67.6 may determine the target variable you wish to predict, such as the average rate. This will be the variable on which you will train your predictive model. Feature Engineering 67.7 may create additional features from the existing data that may impact rates. This can involve using SQL queries to derive new columns or transform existing ones based on domain knowledge and feature engineering techniques.

Building a Predictive Model 67.8 may utilize SQL queries to build a predictive model using machine learning algorithms. Depending on the database system being used, there may be built-in functions or extensions available for machine-learning tasks. Alternatively, you can extract the preprocessed data and use a separate machine-learning framework or library to build the model. Training and Validating the Model 67.9 may split the prepared data into training and validation sets. Use SQL queries to train the model on the training set and evaluate its performance on the validation set. This may involve executing queries to fit the model and calculate evaluation metrics. Predicting Going Rates 67.10 may use SQL queries (e.g., once the data is trained) to provide new input data and obtain predictions for going rates. This can be accomplished by passing the input data through the trained model and retrieving the predicted rates.

Monitoring and Refining the Model 67.11 may continuously monitor the model's performance and refine it as necessary. If the model's performance deteriorates over time or there are changes in the data distribution, updating the training data, retraining the model, or adjusting the model's parameters may be required.

Collecting User Feedback and Making Adjustments 67.12 may gather feedback from domain experts or users and incorporate their insights into the algorithm's inputs or adjustments. This iterative process can help enhance the predictive modeling and ensure its alignment with real-world scenarios.

Aggregation and Analysis 68 may facilitate SQL queries that can be used for data preprocessing, aggregation, and analysis, and machine learning algorithms are typically implemented in separate programming languages or frameworks. These languages and frameworks provide powerful tools, libraries, and APIs that enable efficient development and deployment of machine learning models. By leveraging the capabilities of programming languages and frameworks, the predictive modeling process becomes more accessible and effective. Programming languages such as Python, R, MATLAB, Java, C/C++, and Julia offer extensive support for machine learning tasks. These languages provide dedicated libraries and frameworks that encompass a wide range of algorithms, allowing developers to readily implement regression, classification, clustering, and other machine-learning techniques. These libraries often include functionalities for data preprocessing, feature engineering, model evaluation, and visualization, simplifying the entire machine-learning pipeline. Python, with its prominent libraries like sci-kit-learn, TensorFlow, PyTorch, and Keras, has emerged as a dominant language for machine learning due to its versatility and extensive ecosystem. The rich collection of libraries available in Python allows for seamless integration of various machine-learning algorithms and facilitates experimentation with different models and approaches. R, on the other hand, excels in statistical analysis and provides an extensive range of packages specifically designed for machine learning tasks. Its dedicated libraries, such as caret, randomForest, glmnet, and e1071, offer robust implementations of diverse machine learning algorithms.

MATLAB stands out for its comprehensive Statistics and Machine Learning Toolbox, which provides numerous algorithms, functions, and tools for data analysis, statistical modeling, and machine learning tasks. Its intuitive interface and powerful capabilities make it a favored choice among researchers and professionals in scientific and engineering fields. Java and C/C++ provide the advantage of performance and scalability, making them well-suited for implementing machine learning algorithms in resource-constrained or high-performance computing environments. Libraries like Weka, Deeplearning4j, and Apache Mahout offer Java-based solutions, while TensorFlow, Caffe, and OpenCV provide C/C++ interfaces for developing machine learning models. Julia, a language known for its high-level syntax and performance, also offers machine-learning libraries such as Flux.jl and MLJ.jl. Julia's efficient computation and parallel processing capabilities make it favorable for large-scale machine-learning applications. It is important to acknowledge that programming languages and frameworks continue to evolve, introducing new features, optimizations, and advancements in the field of machine learning. As new algorithms and techniques emerge, programming languages and frameworks are at the forefront of enabling researchers, data scientists, and developers to explore and implement cutting-edge solutions.

By leveraging the power of programming languages and frameworks, the system and method described herein can take full advantage of the rich ecosystem of machine learning tools and resources, enhancing its effectiveness and adaptability in predicting going rates and providing valuable insights for decision-making. For instance, Predict Line Item Rates 68.1 may, when estimating the cost of a project, determine the rates for individual line items. Line items refer to specific components or tasks within the project that require cost estimation, such as materials, labor, equipment, or subcontractor services. To predict line item rates, one can rely on historical data, market research, industry benchmarks, or consultation with experts. Accurate prediction of line item rates is crucial for the overall accuracy of the project cost estimation. Allowing for Minimums 69 may address cases when projects may have minimum requirements that need to be met. These minimums could be related to quantities, hours, or any other specific criteria. When estimating the project cost, it is necessary to account for these minimums and ensure that the cost estimation adequately reflects them. Failing to consider minimums can lead to underestimation and subsequent issues during project execution.

Add for Overhead and Profit 70 addresses overhead costs are indirect expenses incurred during the project, which are not directly attributable to a specific line item. These expenses include administrative costs, utilities, insurance, taxes, and other general expenses. When estimating the project cost, it is crucial to include an allowance for overhead costs to ensure the overall financial viability of the project. Additionally, adding a profit margin is essential to account for the risk, expertise, and effort involved in completing the project. Set Job Price 71 may, once line item rates have been predicted, minimum requirements have been considered, and overhead and profit margins have been added, set the job price. Setting the job price involves aggregating all the estimated costs and determining a final amount that covers all expenses, overheads, profit, and potential contingencies. The job price should also align with market conditions and competitive factors to ensure the project remains financially viable and attractive to clients.

In this manner, the aggregation and analysis are integral steps in the project estimation and costing process. By predicting line item rates, allowing for minimum requirements, adding overhead and profit, and setting the job price, accurate cost estimations can be achieved, leading to successful project planning and execution.

In operation, processes begin with obtaining information from user databases 48, which are values entered by the admin or by either side of the users (buyers or sellers). In most cases, values entered manually from the user's database will overwrite values from other sources, such as automation. Those values are usually collected during sign up, in the user profile, or when a seller posts their listing. The user database information is made up by one or more of the following: Location 49, Rates 50, Specs 51, Images 52, Conditions 53, or any other value entered by users 54. In terms of location 49, the information is obtained when buyers are asked to share the service site's address in the case that it varies from the automatically generated geographic location or the address used to create the user's account. The information of rates 50 is obtained by sellers setting their own asking price for each unit item. Next, specs 51 may include sizes, model serial numbers, heights, weights, and other details regarding the items to be serviced. Users will input the specs of their home and items themselves or by admin. Another source of user database information will be images 52, which are obtained when users have uploaded images to help the other side describe or identify the scope of work. Finally, conditions 53 include input that will help the system determine the age and shape of the item being serviced.

The next obtaining of data occurs by data collection 55, which includes the values generated from combining native system data along with data shared by third party platforms such as API, artificial intelligence (AI) or machine learning, the Internet of Things (IoT), JSON (JavaScript Object Notation), or any other form of automation used to search large sets of data for patterns and trends, turning those findings into business insights and predictions. It can be done using many elements, the first being Geographic location API 56, which provides data and information obtained from a communication interface that identifies users location and returns information about the users geographical position. Geocoding then configures information from the geographic location to obtain and convert geographic positions into street addresses, time zone, currency, real time map navigation, or geotracking, etc., turning those findings into business insights and predictions. The second element is Public Records API 57, which obtains state and county tax records on properties via Application Programming Interface (API) to search for sets of data on ordinance, building code, home size, lot size, number of stories, age, value, etc., turning those findings into business insights and predictions. Manufacturers API 58 obtains information via API to search for sets of data on items specs, ingredients, repair manuals, maintenance recommendations, etc., turning those findings into business insights and predictions. Supplies API 59 searches home improvement supplies, contractors supplies etc. via API to search for sets of data on items prices, descriptions, depreciation, etc., turning those findings into business insights and predictions. Retailers API 60 studies department store or furniture retailers etc. via API to search for sets of data on items sold date, the person sold to, delivery location etc., turning those findings into business insights and predictions. Real Estate Marketplaces API 61 obtains information via API to search for sets of data on home specs, images, sales history, market value etc., turning those findings into business insights and predictions. Utility Companies API 62 searches for sets of data that can help with the type of appliances used whether it's gas or electric along with more information that's not limited to energy consumption, usage, etc., turning those findings into business insights and predictions. Estimate software API 63 includes, but is not limited to, auto, construction, restoration, remodeling softwares, etc., via API to search for sets of data for line-items such as prices, descriptions, depreciation, waste, minimums, labor overhead, profits, etc., turning those findings into business insights and predictions. Insurance API 64 searches for sets of data on statistics, frequencies, and how often a water heater leaks from resources such as the Department of Insurance, insurance carriers, adjusters, or agents via API, turning those findings into business insights and predictions. Technology platforms 65 can provide analytic databases not limited to software, data, artificial intelligence (AI) or machine learning, and the Internet of Things (IoT) by any means to search for sets of data turning those findings into business insights and predictions. Lastly, any other data as it becomes available 66 refers to departments such as OSHA or the Department of Labor who are constantly evolving technology and constantly innovating new methods of collecting and sharing data (API or JSON).

The next main step of computing can begin. Computing 67 uses every data set from the user database 48 and the collected data 55 to produce useful information that can predict quantities, unit prices, and data analytics. The program algorithms can be adjusted by the system designers to set the weight of consideration of each data set from either user databases sources 48 or one or a combination of the automatically generated values predicted from data collection 55. The program then uses obtained findings to identify values such as quantities and rates. Next, the system will determine line-item prices 68 by using data from the computing step 67, such as quantities and rates, to calculate the values to set a price. Next, the program uses the obtained findings from line-item prices 68 to identify and predict items to compute materials waste and labor minimums 69. It will also use the total amount from 68 and 69 to identify and predict overall job overhead and profit 70. Finally, the program uses all of the above obtained findings combined to predict an overall job price 71. This same method may apply on a wide range of predicting value of other services such as gig economy, booking, lessons, renting, professional services or any on demand services, helping in turning intangible service to be as predictable as tangible products.

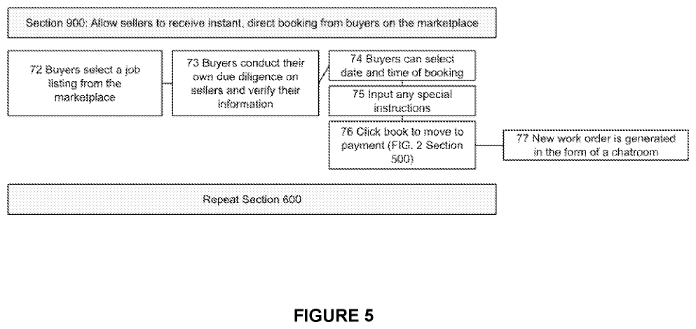

FIG. 5 depicts how buyers can search and browse posted job listings on the marketplace and book directly from service sellers themselves. The process begins with buyers choosing the service they would like to book 72. Buyers should then do their own research on the seller they want to book from to ensure they will have the best experience possible 73. This can include reading their profile information, noticing which credentials they have uploaded, viewing their rank, and any other further research to learn about the seller. Once sure about the service they want to book, buyers can then select a date from the available times on the calendar to schedule for 74. They will have a field for special instructions they have about the service they need completed that will be sent to the seller upon booking 75. The buyers then click the Book button 76 which redirects them to the payment process explained in Section 500 of FIG. 2. A new work order is then generated in the form of a chatroom 77 which begins the process referenced in FIG. 2 Section 600.

FIG. 6 illustrates the buyer's perspective requesting a custom offer from a seller. The process begins with the buyer opening a “Request custom offer form” 78 to fill out. They will first describe the unique service they would like to schedule 79. They can then attach any relevant pictures 80 to further describe what they need help with. They will then send this offer to the service seller 81. The service seller will then receive this custom offer request form 82 and read the description of the request the buyer has asked for 83. From here, the process picks up from FIG. 2, Section 300 where the seller sends back a custom offer. They will repeat the steps 15-19 in FIG. 2, Section 300. Once the seller sends back their response to the buyer 19, the buyer opens up the response 20 and views what custom service they can offer. The buyer will then repeat steps 20-31 from FIG. 2, Section 400. If they choose to accept the offer and continue 21, they will book a day from the available times 24 and make a payment 25. The payment is now held in escrow and begins a new work order as demonstrated in FIG. 2, Sections 500 and 600 respectively.

FIG. 7 shows the self-serve marketplace of seller's jobs listings specific to each buyer or location. The program by default sorts job cards 84 by distance 85, allowing users to scroll and shop for nearby services. Users can also use the search bar 86 to look for a specific service or browse by category. Clicking on a job card will open up a page of the listing's details and allow buyers to book the service. Clicking on the seller's username 87 will lead users to that seller's public profile.

FIG. 8 illustrates the Chat tab 88, which shows a list of active and completed work orders in the form of chat rooms. Both sides of users, buyers and sellers, can access work orders from chat or their Orders page (See FIG. 9). They can also use the search bar 89 in the Chat tab to search users or keywords in messages.

FIG. 9 displays the orders dashboard for both sellers and buyers where they can view their schedule and list of booked jobs. Days with booked appointments will be highlighted with a different color to indicate it is not empty. Each job includes a summary of the most important details users will need to know 90, such as who booked the job, what was booked, the buyer's address, the buyer's picture, and the date and time of the service. This Orders page is also where users can view their KPI 91.

FIG. 10 shows the dynamic work order, which is created in the form of a chat room instantly after a customer places an order. In the chat, the program allows users to communicate through text 92, upload media 93, and perform actions such as cancel, request a redo of the service, accept delivery 94, and leave reviews once the job is done. The dynamic work order cycle comes to an end once the seller marks the job as completed and the buyer accepts delivery. The chatroom will still be viewable but no messages are permitted to be sent from this point onward. If they wish to communicate further, users can create a new work order through normal booking or the custom offer feature. The last step of the work order involves the system requesting users to rate each other, leave reviews, or give anonymous feedback.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

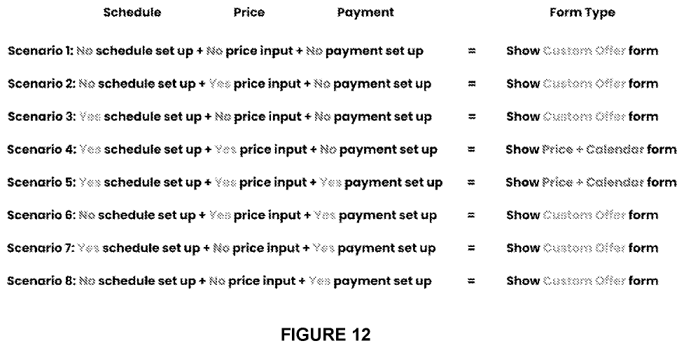

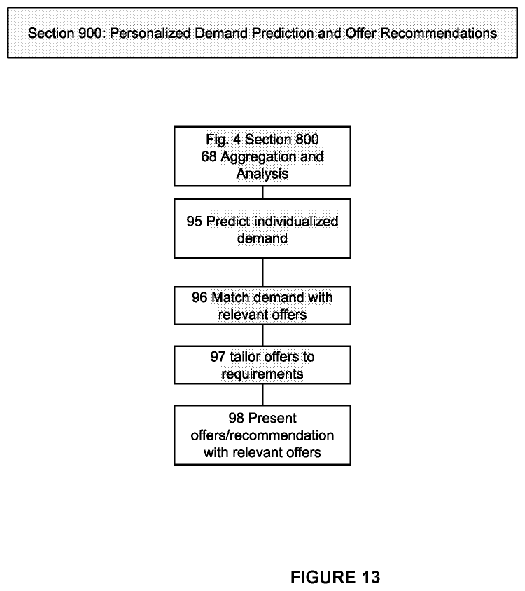

FIG. 13 shows the Personalized Demand Prediction and Offer Recommendations workflow. The Personalized Demand Prediction and Offer Recommendations feature utilizes data reprocessing techniques used in FIG. 4 Section 800 (48-68) to predict the individualized demand (e.g., FIG. 12 at 95) of users and match them with relevant offers (e.g., FIG. 12 at 96). By analyzing aggregated data and applying advanced analysis methods, the platform can understand user preferences, anticipate their needs, and tailor offers specifically to their requirements. For example, suppose the data indicates that a homeowner purchased a water heater nine years ago, and the average lifespan of a water heater is typically ten years. Leveraging the Aggregation and Analysis capabilities of the platform, it can identify this user's potential need for a water heater replacement and proactively recommend nearby plumbers who offer water heater replacement services.

An implementation considers various factors such as historical purchase data, user behavior, demographic information, and market trends to make personalized predictions. These predictions enable the platform to anticipate when users are likely to require specific products or services and present them with timely and relevant offers at 98. This feature benefits both users and service providers. Users receive tailored recommendations that align with their needs, saving them time and effort in searching for relevant offers. Service providers, on the other hand, can target their marketing efforts more effectively, reaching potential customers who are actively seeking their services. In this manner, the Personalized Demand Prediction and Offer Recommendations feature enhances the user experience by leveraging data analysis to predict individualized demands and connect users with relevant offers. It increases efficiency, reduces search costs, and fosters a more personalized and targeted marketplace experience for both users and service providers.

In certain implementations, portions of the system may be implemented in cellular phones or other personal digital assistants (PDAs), which are generally configured with flash memory to provide non-volatile memory for storing operating system files and/or user-generated data. A bus system may include one or more buses, such as a system bus, an 1/O bus and a PCI bus. The bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, a cache or main memory or CPU memory. A processing unit may include one or more processors or CPUs. Described examples are not meant to imply architectural limitations. For example, portions of the computing system also may be implemented in a personal computer, server, server cluster, tablet computer, or laptop computer in addition to taking the form of a PDA. Particular embodiments of the computing system can take the form of an entirely hardware embodiment or an embodiment containing both hardware and software units. In a particular embodiment, the disclosed methods are implemented in software that is embedded in processor readable non-transitory medium and executed by a processor, which includes but is not limited to firmware, resident software, microcode, etc.

Further, embodiments of the present disclosure, such as the one or more embodiments in the figures may take the form of a computer program product accessible from a computer-usable or computer-readable medium providing program code for use by or in connection with a computer or any instruction execution system. For the purposes of this description, a non-transitory computer-usable or computer-readable medium can be any non-transitory medium that can tangibly embody a computer program and that can contain or store the computer program for use by or in connection with the instruction execution system, apparatus, or device.

In various embodiments, the medium can include an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory units through a system bus. The memory units can include local memory employed during actual execution of the program code, bulk storage, and cache memories which provide temporary storage of at least some program code in order to reduce the number of times code must be retrieved from bulk storage during execution.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

The methods and systems described herein are not limited to the specific embodiments described herein. For example, components of each system and/or steps of each method may be utilized independently and separately from other components and/or steps described herein. For example, the method and systems may also be used in combination with other combustion systems, and are not limited to practice only with the gas turbine engines as described herein. Rather, the exemplary embodiment can be implemented and utilized in connection with many other rotary machine and combustion applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method of generating a work order, the method comprising:
performing a task selected from a list comprising at least one of: demand forecasting, tailored pricing, service provider matching, and dynamic job order management;
based on the performed task, matching a user with a nearby service professionals via a marketplace network to generate a job order; and
managing the job order.
